(19) United States
(12) Patent Application Publication
(10) Pub. No.: US 2025/0338980 A1
(43) Pub. Date: Nov. 6, 2025

(54) TRI-FOLD REFLECTIVE VIDEO DISPLAY APPARATUS FOR INTERACTIVE TUTORIALS

(71) Applicants: Ekaterina Kovaleva, Phuket (TH); Colin Craig Brackenridge, Phuket (TH)

(72) Inventors: Ekaterina Kovaleva, Phuket (TH); Colin Craig Brackenridge, Phuket (TH)

(21) Appl. No.: 18/654,029

(22) Filed: May 3, 2024

(51) Int. Cl. A47G 1/04; A47G 1/16; G09G 5/00

(52) U.S. Cl. CPC A47G 1/04; A47G 1/1653; G09G 5/006; A47G 2200/08; A47G 2200/143

(57) ABSTRACT

The present invention discloses a tri-foldable smart mirror designed for hairstyling and beauty routines, integrating storage solutions and digital technology to enhance the user experience in personal grooming. The Tri-Fold Reflective Video Display Apparatus For Interactive Tutorials, also called ‘tri-fold smart mirror’ comprises a central mirror and a two hinged side mirrors. The tri-fold smart mirror is designed for hairstyling and beauty routines, integrating storage solutions and digital technology to enhance the user experience in personal grooming. The central mirror flanked by two hinged side mirrors, forming a tri-fold design. When closed, it forms a compact, flat structure, and when open, it offers a panoramic view for hairstyling. The central panel features a 13.3″ HD digital display powered by Android 11, providing interactive functionalities such as access to hairstyling tutorials, health monitoring apps, and customizable settings.

### CROSS-REFERENCE TO RELATED APPLICATIONS

The U.S. Pat. No. 10,318,145B2 that was published in 2019 discloses a smart mirror. An image storing and display that is combined with a conventional mirror to create a “smart mirror.” A one-way reflective surface is provided over the top of an interactive display. A person in front of the reflective surface can see a normal reflection as would be provided by a conventional mirror. The person can also see images created by the interactive video display that are transmitted through the one-way reflective surface. A camera provided as part of a smart mirror can be used to record digital images that are stored for later recall. The recalled images can then be displayed on the interactive display. A computer is used to drive the interactive display. The display preferably includes touch-based interaction.

### PRIOR ART

A smart mirror is a mirror with ‘smart’ capabilities much like how cell phones have become smart. That is, it is a display that looks and acts like a mirror, but has the capability of displaying multimedia data through the mirror glass as if the mirror was a screen on its own accord. A common approach to building a smart mirror is to use a pane of two-way glass, a monitor, a frame to hold the glass and monitor, and a web browser with JavaScript to provide the software features and drive the display. The main limitation of this setup is related to the use of a browser as the display's method of information presentation.

Conventional mirrors and hairstyling methods have limitations, particularly in providing comprehensive visibility, especially at the back of the head, and integrating technological advancements for modern beauty routines.

Additionally, the lack of integrated storage solutions in existing mirrors presents a missed opportunity for functionality.

Traditionally, people have relied on external assistance from hairdressers, friends, or stylists to create desired hairstyles, which can be both costly and time-consuming. The primary challenge lies in the inability to see and effectively style the back of their own heads, hindering their ability to replicate professional-looking hairstyles at home.

The current market is saturated with hairstyle video tutorials on social media platforms, attracting a massive following. However, these tutorials often fall short in practical application, as users encounter limitations in visualizing and executing the steps required to style the back of their heads. This frustration has led to a demand for an innovative solution that empowers individuals to achieve salon-quality hairstyles independently.

However, the invention being taught in the prior art is different from the one being proposed by the present invention.

Therefore, there is a need for an improved smart mirror as part of the personal grooming devices.

### BACKGROUND OF THE INVENTION

Traditionally, people have relied on external assistance from hairdressers, friends, or stylists to create desired hairstyles, which can be both costly and time-consuming. The primary challenge lies in the inability to see and effectively style the back of their own heads, hindering their ability to replicate professional-looking hairstyles at home.

While basic tri-fold mirrors on platforms like Amazon do exist, they fall short in functionality. The tri-fold smart mirror is a smart mirror that leverages advanced technology to overcome limitations. Unlike other tri-fold mirrors that obstruct the view and hinder styling, the tri-fold smart mirror's exclusive technology projects the user's back head onto the mirror, ensuring a clear view and facilitating precise styling.

Furthermore, the current hair market is saturated with video tutorials on social media platforms, attracting a massive following. However, these tutorials often fall short when it comes to practical application, as users encounter limitations in visualizing and executing the steps required to style the back of their heads. This frustration has led to a demand for an innovative solution that enables individuals to achieve salon-quality hairstyles independently.

### SUMMARY OF THE INVENTION

By addressing the shortcomings of traditional salons, basic tri-fold mirrors, and popular vloggers, the tri-fold smart mirror invention offers an innovative solution. The invention seamlessly integrates advanced technology, convenience, and affordability, revolutionizing the way people approach hair and beauty routines. The interactive hardware and software provide an exceptional user experience, setting it apart in the industry.

The invention offers a convenient and cost-effective at-home solution that empowers individuals to achieve salon-quality looks without the need for expensive appointments or travel. By providing a simple and user-friendly platform, the tri-fold smart mirror saves its customers time and money, giving them the freedom to style their hair at their own pace and convenience.

The tri-fold smart mirror invention has a distinct competitive advantage that sets it apart in the hair and beauty industry. While the presence of competitors and alternative solutions is acknowledged, the tri-fold smart mirror's unique offering provides significant value and addresses the limitations of existing options.

Embodiments described herein are directed to a reflective video display apparatus (also referred to herein as a ‘tri-fold smart mirror’ designed for hairstyling and beauty routines, integrating storage solutions. The tri-fold smart mirror is configured to display video content, such as a pre-recorded tutorial led by an instructor, to a user and provide an interface that allows the user to interact and personalize the user experience.

The tri-fold smart mirror features a tri-fold design incorporating smart technology, hidden storage compartments, and advanced hairstyling capabilities through its digital interface and mobile app integration. This innovative design offers a full 360-degree view, aiding in intricate hairstyling.

The integrated HD display, coupled with a mobile application, provides access to a range of hairstyling tutorials and health monitoring tools. The hidden storage compartment adds functionality, allowing users to store valuables and beauty accessories. This invention significantly advances the standard of home-based grooming tools by integrating multiple features into one cohesive unit.

The detailed description that follows and the drawings that are referred to in the detailed description will further describe the embodiments described in the summary as well as other embodiments. Accordingly, to understand all the embodiments described by this document, a full detailed description and drawings is needed.

### BRIEF DESCRIPTION OF DRAWINGS

A skilled person will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

The illustrative embodiments, however, as well as a preferred mode of use, further objectives, and descriptions thereof, will best be understood by reference to the following detailed description of one or more illustrative embodiments of the present disclosure when read in conjunction with the accompanying drawings.

FIG. 1 illustrates the full arrangements of placing of tri-fold smart mirror on a tripod.

FIG. 2 illustrates an isometric view of the tri-fold smart mirror when folded.

FIG. 2A illustrates the top view of the folded tri-fold smart mirror.

FIG. 2B illustrates the front view of the folded tri-fold smart mirror.

FIG. 2C illustrates the bottom view of the folded tri-fold smart mirror.

FIG. 2D illustrates the side view of the folded tri-fold smart mirror.

FIG. 3 illustrates an isometric view of the tri-fold smart mirror unfolded.

FIG. 3A illustrates the top view of the unfolded tri-fold smart mirror.

FIG. 3B illustrates the front view of the unfolded tri-fold smart mirror.

FIG. 3C illustrates the bottom view of the unfolded tri-fold smart mirror.

FIG. 3D illustrates the side view of the unfolded tri-fold smart mirror.

FIG. 4 illustrates the exploded model of the tri-fold smart mirror.

FIG. 5 illustrates several features within the center mirror of tri-fold smart mirror.

FIG. 6 illustrates the LED surround within the left-side mirror of the tri-fold smart mirror.

FIG. 7 illustrates Material plastic for the right-side mirror of the tri-fold smart mirror.

FIG. 8 illustrates an isometric view of the plastic tray (base) of the tri-fold smart mirror.

FIG. 9 illustrates an isometric view of the plastic holding bar used to connect the plastic tray (FIG. 8) and center mirror of the tri-fold smart mirror.

FIG. 10 illustrates a smart device that analyses a user's skin condition.

FIG. 11A(1) illustrates a HD Mini 4K Wireless Video Camera.

FIG. 11A(2) illustrates a flexible tripod for HD Mini 4K Wireless Video Camera.

FIG. 11A(3) illustrates a Flexible Gooseneck Suction Cup Mount.

FIG. 11A(4) illustrates a Flexible Gooseneck Metal Clip Mounting Bracket.

FIG. 12(1) illustrates the Home Screen.

FIG. 12(2) illustrates the Progress Screen.

FIG. 12(3) illustrates the Voice Activation and Voice Search Screen.

FIG. 13 illustrates the Face Recognition for Face Analysis and Skin Analysis Screen.

FIG. 14 illustrates the Face Fitness (Face Yoga, Face Gym, Face exercises) Screen.

FIG. 15 illustrates the Applications and Message Screen.

FIG. 16 illustrates the Hairstyle Video Tutorial Screen.

FIG. 17 illustrates the Popular Mentors Screen.

FIG. 18 illustrates the Shop/Marketplace Screen.

FIG. 19 illustrates the My Favourites Screen.

FIG. 20 illustrates the Hairstyle Search Screen.

FIG. 21 illustrates the Discover Latest Fashion Look Screen.

FIG. 22 Illustrates the Community and Social Media Screen.

FIG. 23 illustrates one of the Mobile App Onboarding Screens.

FIG. 24 illustrates the Mobile App Home Screen.

FIG. 25 illustrates the Mobile App Tutorial Completion Screen.

FIG. 26 illustrates the Mobile App My Favourites Screen.

FIG. 27 illustrates how a user can save tutorials to My Favourites and pop-up window shows how a user can remove a tutorial from My Favourites.

FIG. 28 illustrates the Mobile App's advanced Hairstyle Filters Screen.

FIG. 29 illustrates the Mobile App Hairstyle Search Screen.

FIG. 30 illustrates the Mobile App's Top Mentors Screen.

FIG. 31 illustrates the Mobile App's Mentors Bio Screen.

FIG. 32 illustrates the Mobile App's Mentors Review Screen.

FIG. 33 illustrates the Mobile App's Popular Tutorials Screen.

### DETAILED DESCRIPTION OF THE INVENTION

Various embodiments and aspects of the invention will be described with reference to details discussed below, and the corresponding drawings will illustrate the various embodiments.

The following description and corresponding drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present invention.

The present invention is to provide an advanced smart mirror designed for hairstyling and beauty routines, integrating storage solutions and digital technology to enhance the user experience in personal grooming.

The integrated HD display, coupled with a mobile application, provides access to a range of hairstyling tutorials and health monitoring tools. The hidden storage compartment adds functionality, allowing users to store valuables and beauty accessories. This invention significantly advances the standard of home-based grooming tools by integrating multiple features into one cohesive unit.

The detailed description that follows and the drawings that are referred to in the detailed description will further describe the embodiments described in the summary as well as other embodiments. Accordingly, to understand all the embodiments described by this document, a full detailed description and drawings is needed.

Unlike other tri-fold mirrors that obstruct the view and hinder styling, the tri-fold smart mirror herein holds exclusive technology which projects the user's back head onto the center mirror, ensuring a clear view and facilitating precise styling.

The tri-fold smart mirror consists of a central mirror 1 flanked by two hinged side mirrors, forming a tri-fold design. When closed, it forms a compact, flat structure, and when open, it offers a panoramic view for hairstyling. The central mirror 1 features a 13.3″ HD digital display powered by Android 11, providing interactive functionalities such as access to hairstyling tutorials, health monitoring apps, and customizable settings.

The rear of the central panel houses a concealed compartment for storing hair and beauty accessories. The mirror's design is sleek and modern, with adjustable LED lighting and a frameless appearance. Its construction allows for tabletop, wall-mounted setups as well as tripod stands, catering to various user preferences.

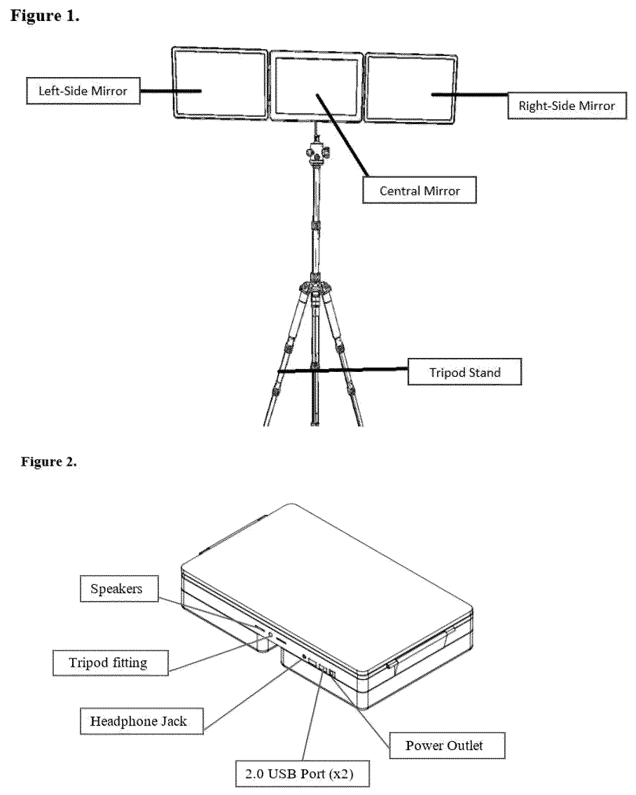

FIG. 1 states the left-side, right-side and central mirror unfolded and situated on a Tripod Stand. The unique design in the concealed storage compartment allows for easy attachment to any tripod stand.

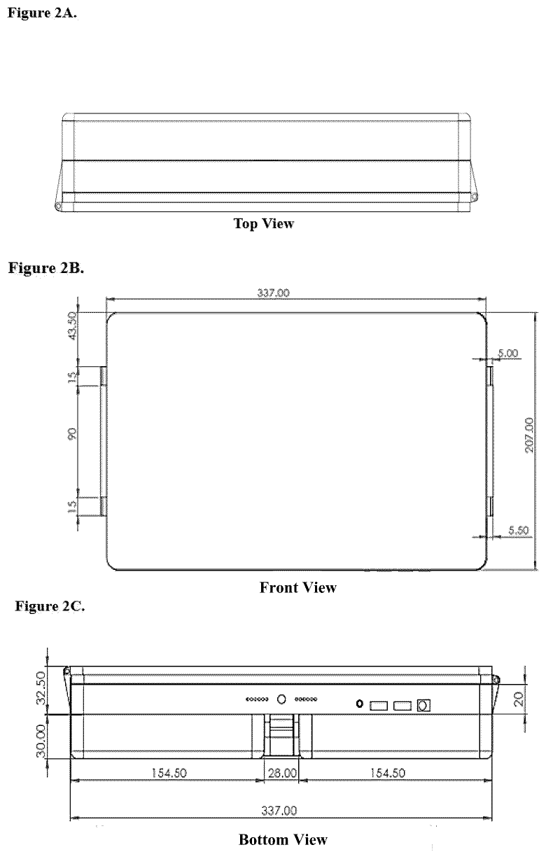

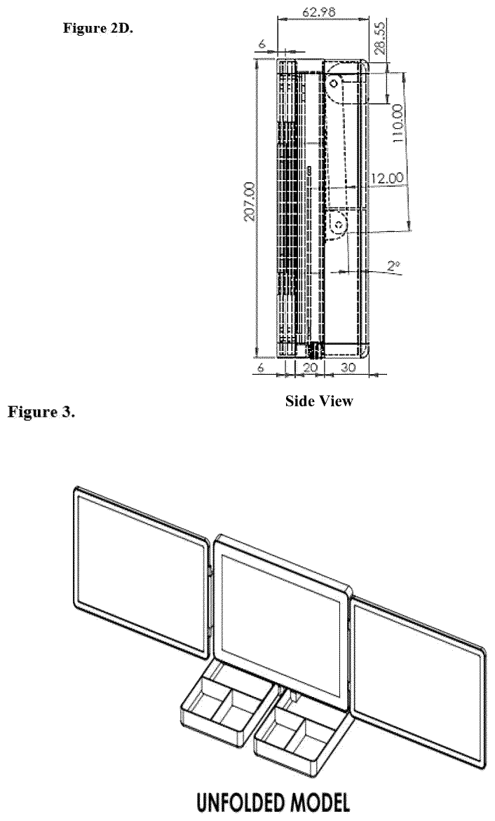

FIG. 2 illustrates the Folded Model describing the Top view in FIG. 2A, Front view in FIG. 2B, bottom view in FIG. 2C, and side view in FIG. 2D, where it describes the top, front, bottom and side view with proper dimensions. Contained within the middle mirror's plastic casing are built-in speakers, provision for tripod connection, headphone jack, two 2.0 USB ports and power outlet port. These are also depicted in bottom view in FIG. 2C.

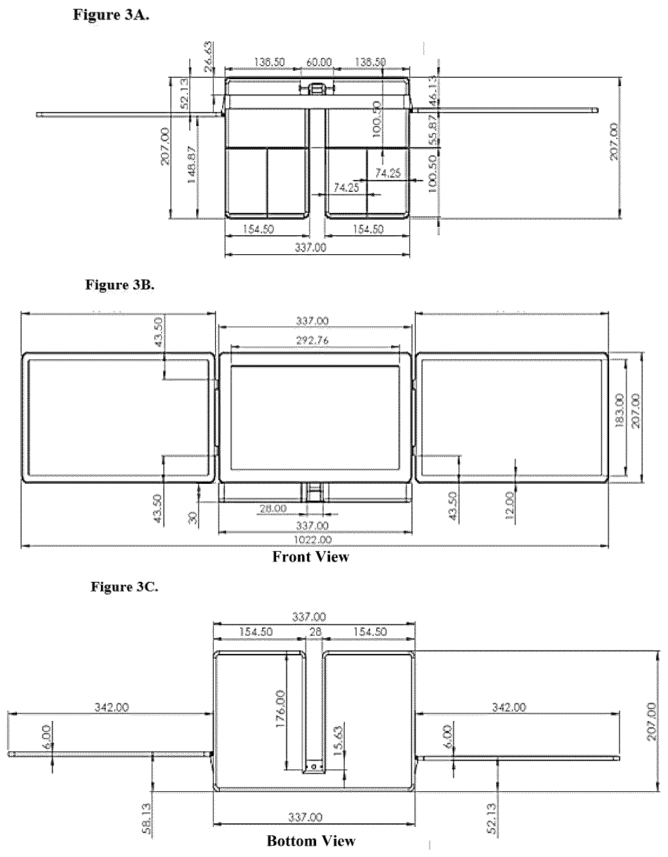

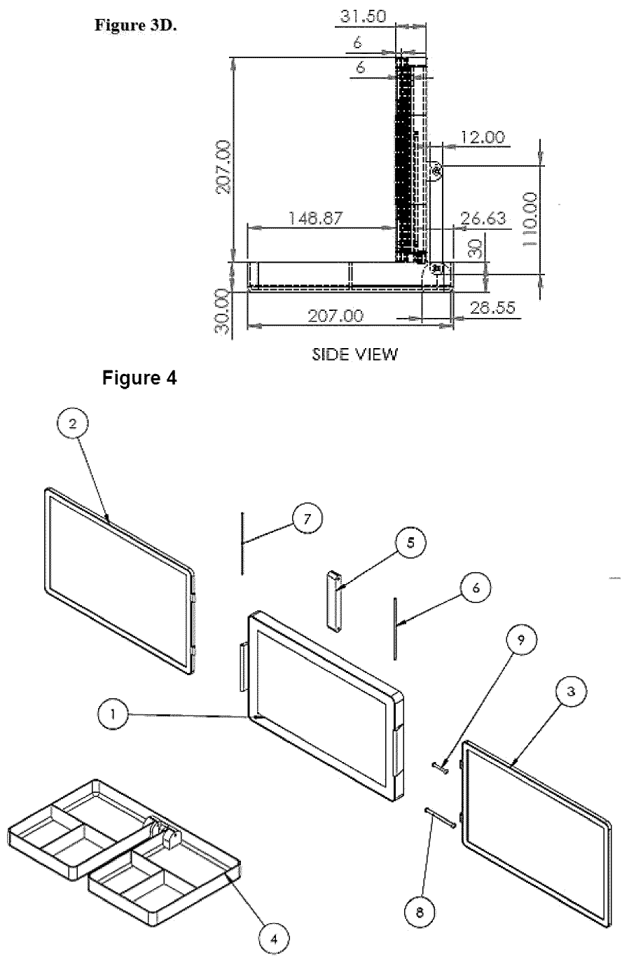

FIG. 3 illustrates the Unfolded Model describing the Top view in FIG. 3A, Front view in FIG. 3B, bottom view in FIG. 3C, and side view in FIG. 3D, where it describes the top, front, bottom and side view with proper dimensions.

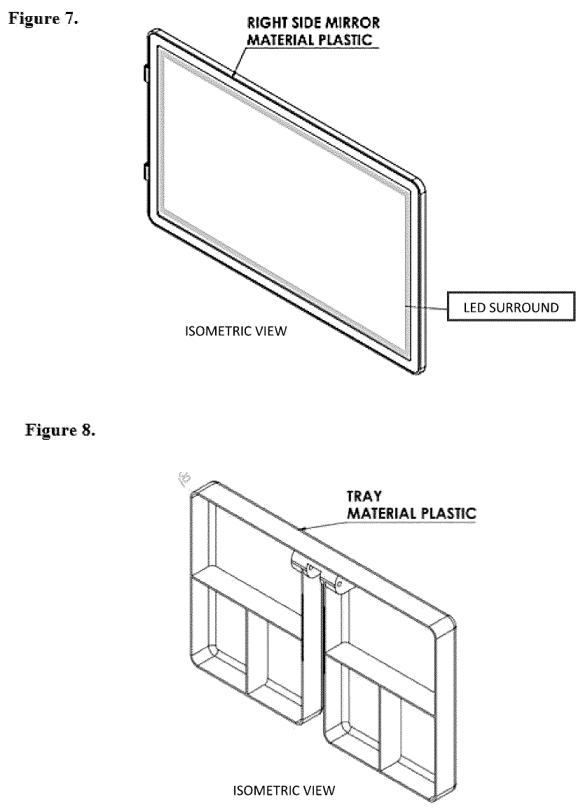

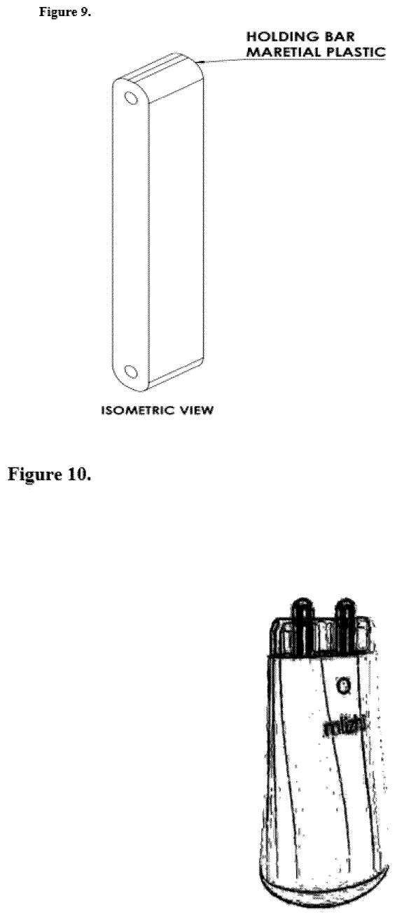

FIG. 4 describes the Exploded Model with numbering from 1 to 9:
Number 1—specify the Middle Mirror indicates material plastic with speaker, provision for tripod connection and output port.
Number 2—specify the Left-Side Mirror in Drawing/FIG. 6 of the drawings given.
Number 3—specify Right-Side Mirror in Drawing/FIG. 7 of the drawings given.
Number 4—specify the Tray in Drawing/FIG. 8 of the drawings given.
Number 5—specify Holding Bar in Drawing/FIG. 9 of the drawings given.
Number 6—specify Hinge for right side mirror with 120 mm length, 2.9 mm diameter with metal hinge.
Number 7—specify Hinge for left side mirror with 120 mm length, 2.9 mm diameter with metal hinge.
Number 8—specify Bottom hinge for holding bar with 606 mm length and 4.8 diameter.
Number 9—specify Top Hinge for holding bar with 28 mm length and 48 mm diameter.

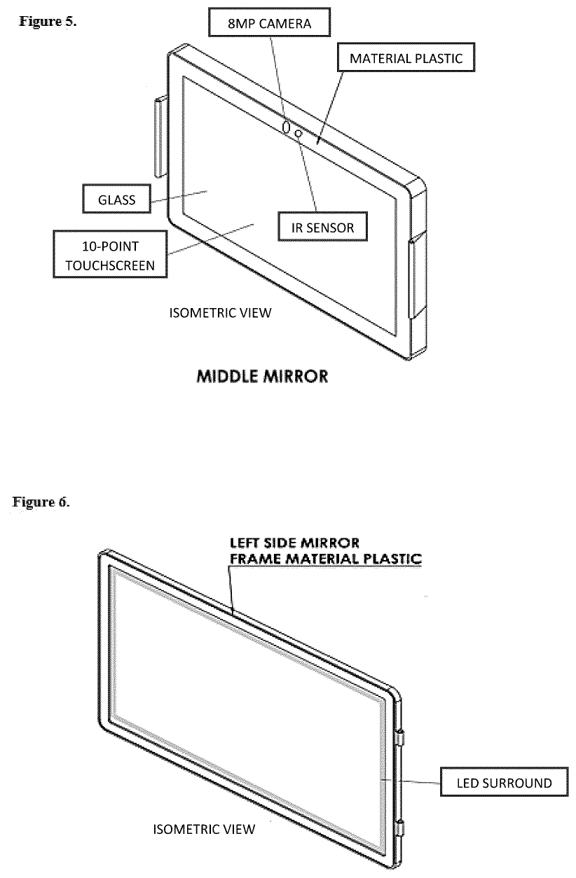

FIG. 5 describes the Isometric View of the Middle Mirror of the tri-fold smart mirror with an 8 MP camera, Material plastic, IR sensor, Glass with a 10-point touchscreen.

FIG. 6 describes the Isometric View of the Left-Side Mirror with Material plastic and LED surrounds.

FIG. 7 describes the Isometric View of the Right-Side Mirror with Material plastic and LED surrounds.

FIG. 8 describes the Isometric View of Material plastic for compartment tray of the tri-fold smart mirror.

FIG. 9 describes the Isometric View of Material plastic for the holding bar of the tri-fold smart mirror.

FIG. 10 describes a Smart Device that analyses a user's skin condition. A user must place the two pins shown in FIG. 10 on the surface of their skin and the tri-fold smart mirror will reveal a user's skin condition, dryness, hydration level, blemishes and recommend products and services to improve a user's skin.

In the provisional patent application for a Tri-Fold Reflective Video Display Apparatus For Interactive Tutorials (tri-fold smart mirror), it's important to emphasize the pivotal role of the accompanying accessories that enhance the functionality and user experience of the device. While these accessories may not be the subject of the patent application themselves, they are integral components of the tri-fold smart mirror ecosystem and will be sold as part of a comprehensive package alongside the mirror. Descriptions of these accessories are below, and include a HD Mini 4K Wireless Video Camera, a Flexible Tripod for a HD Mini 4K Wireless Video Camera, a Flexible Gooseneck Suction Cup Mount, and a Flexible Gooseneck Metal Clip Mounting Bracket.

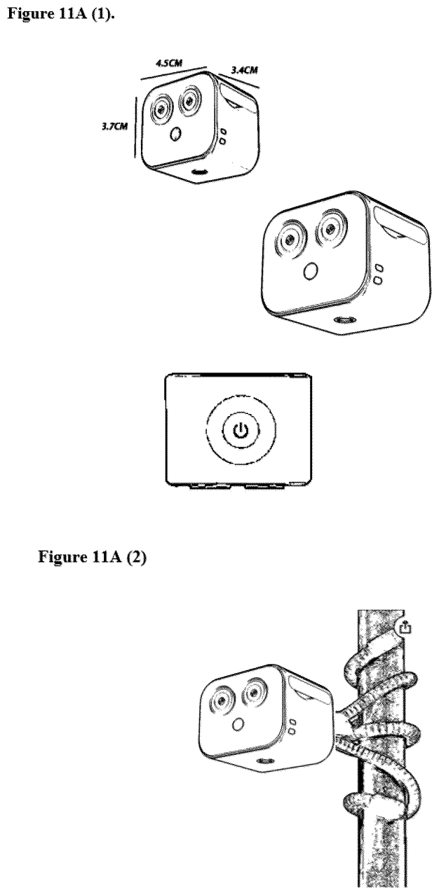

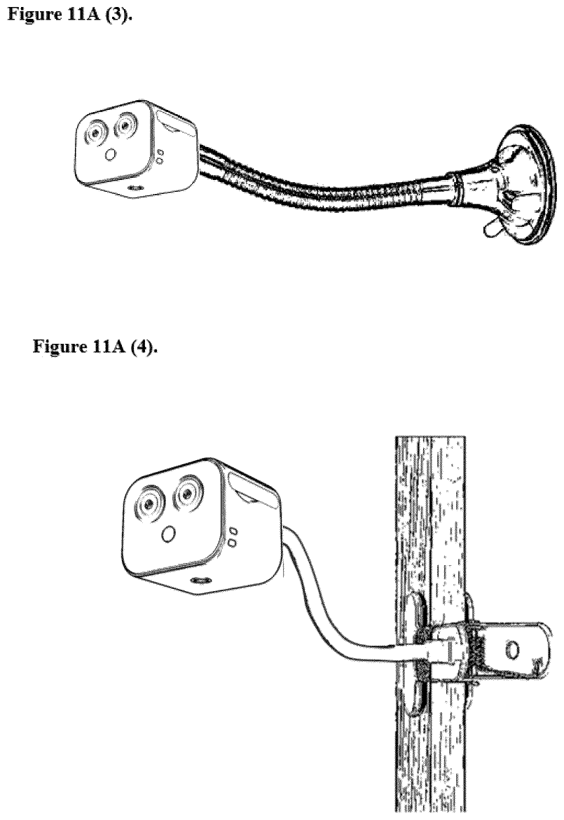

FIG. 11(1) illustrates a HD Mini 4K Wireless Video Camera with Ultra-high-definition, Infrared LED Night vision, App mobile phone remote viewing, Wi-Fi remote viewing, 4K dual-lens high-definition resolution, supporting two-way intercom voice real-time calls, with magnetic body for quick attachment to any magnetic surface, TF memory card (max 128 GB), Power interface with USB, Telephoto lens, Wide-angle lens (170 degrees), 16 million pixels (dual lens 32 million pixels), Video resolution (4 k), Built-in battery, Speaker, Microphone, Wi-Fi, convenient installation with 360 rotating magnetic bracket. The camera requires no drilling or welding and has a ¼ threaded interface for tripod mounting.

Functions of the HD Mini 4K Wireless Video Camera includes taking photos, videos, audio recording, remote viewing via Wi-Fi to any mobile phone brand or tablet, remote control LED light to turn on/off, can be powered by power bank or socket, or with its own battery to continue Video recording, non-stop recording when power off, built-in hotspot connection, disconnected video recording.

FIG. 11(2) illustrates a Flexible Tripod for a HD Mini 4K Wireless Video Camera. A compact yet flexible tripod stand, designed to wrap around any pole or fixture, providing stable support. Outfitted with 6-inch length adjustable arms that wrap around poles or act as supportive tripod legs, the tripod provides plenty of mounting options and can be adjusted in any direction to achieve the perfect viewing angle. The three premium aluminium legs are wrapped by high-density silicone rubber and allows a user to adjust a camera in various angles for superior perspectives. The legs are non-slip and simple to install-no tools, screws or drilling holes are required.

FIG. 11(3) illustrates a Flexible Gooseneck Suction Cup Mount offering convenient of attachment to any flat, smooth surface, ensuring optimal positioning for a camera. The Flexible Gooseneck Suction Cup Mount has a swivel ball adapter head and an 8.5-inch gooseneck providing flexibility for positioning a camera. No tools are required, no drilling holes or causing wall damages. Just attach it to a camera then lock it on a smooth surface such as window, tile, metal or glass. This mount is made of high-quality material and strong suction cup to ensure the stability in order to protect a camera from falling down.

FIG. 11(4) illustrates a Flexible Gooseneck Metal Clip Mounting Bracket providing secure attachment to doors, desks, and various other items. This mounting bracket comes with standard ¼ threaded hole. The arm of the gooseneck is made of aluminium and magnesium alloy. The non-slip clamp is covered with foam material to prevent damage and scratches to clamping surfaces. The metal clamp can be adjustable up to 2.2 inches surface thickness. The Gooseneck Arm's Length is 8.3 inches. Very easy to install, just clamp it to a desk, table, door, curtain, etc. Any angle is possible as is easily adjustable and flexible to position a camera. No tools required-No screws, no drilling.

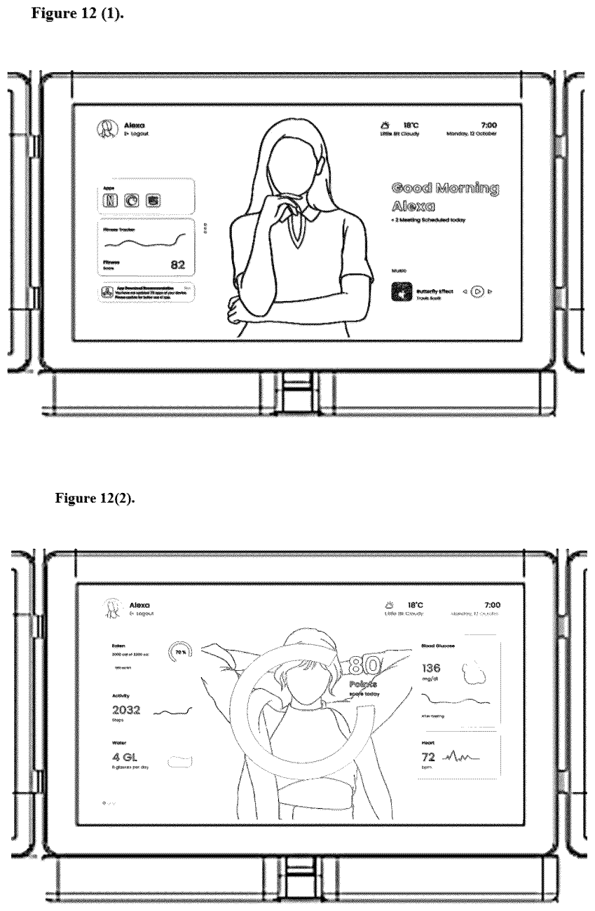

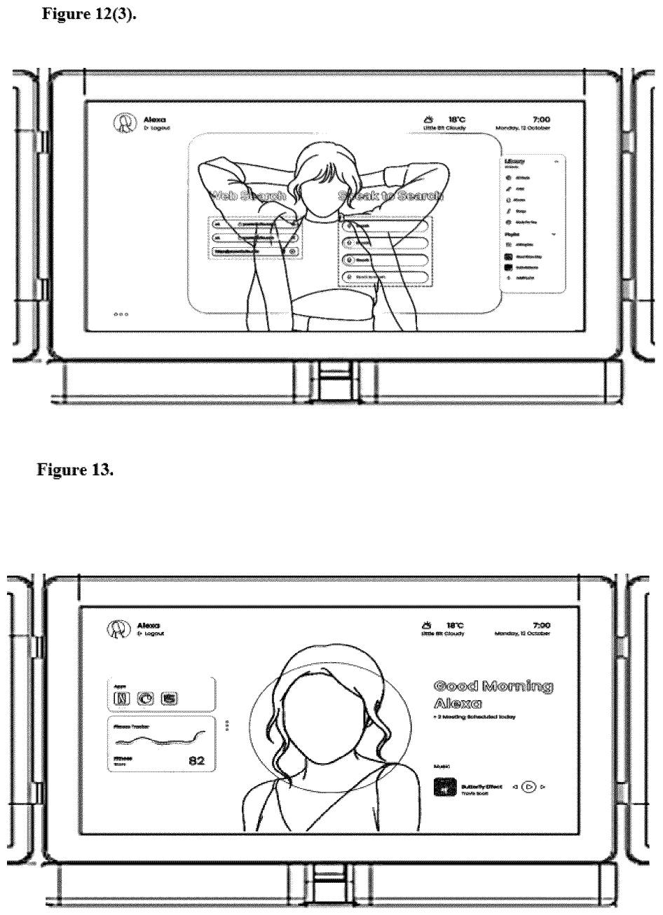

FIG. 12(1) illustrates the Home Screen. The home screen is a snapshot of the user's virtual currency, providing a quick overview of their virtual currency accumulation. Daily hair and skin recommendations further enhance the user experience, offering personalized insights to cater to their beauty and wellness needs. Integrated into the home screen is a Spotify music widget, enabling users to set the ambiance with their favorite tunes while engaging with the mirror. Additionally, widgets displaying the time, weather, and a personalized welcome note contribute to a holistic and user-centric interface.

FIG. 12(2) illustrates the Progress Screen. The Progress Screen also offers a quick snapshot of the user's skincare and body health. Users can access real-time information on their skin's health and body fat levels, gaining valuable insights into their well-being. The screen may further include tailored recommendations for skincare products to improve skin health. In addition to virtual currency and health metrics, the Progress Screen may showcase other relevant statistics and achievements, providing users with a holistic view of their tri-fold smart mirror journey. This consolidated and user-centric approach on the Progress Screen aims to motivate users, foster engagement, and offer personalized insights for their overall well-being.

FIG. 12(3) illustrates the Voice Activation and Voice Search Screen. The Voice Recognition feature on the tri-fold smart mirror app introduces an innovative and hands-free approach for users to interact with the mirror. This screen empowers users to effortlessly search the web or find specific services within the application using speech commands. By simply activating the voice recognition function, users can initiate searches, access tutorials, or explore beauty content without touching the screen. In addition to voice commands, this screen serves as a centralized hub for users to customize their tri-fold smart mirror experience through the Settings Menu. Here, users can seamlessly adjust connectivity settings such as Wi-Fi and Bluetooth, adjust LED settings, ensuring the mirror is integrated into their preferred network and devices.

FIG. 13 illustrates the Face Recognition for Face Analysis and Skin Analysis Screen. The Face Recognition screen on the tri-fold smart mirror app facilitates a seamless user experience. Users are guided to position their face within a designated graphic on the screen. Upon alignment, the front-facing camera captures photos of the user's face, initiating a comprehensive skin analysis. Once the images are acquired, users are seamlessly transitioned to another screen where they can view the detailed results of their skin analysis, providing valuable insights and personalized recommendations for an enhanced skincare routine. Three health center applications are provided, Skin Detect, Body Condition Checking and Face Fitness (Face Yoga, Face Gym, Face exercises). These apps enable real-time tracking of skincare and body fat, offering users valuable insights into their health. Progress can be monitored, empowering users to make informed decisions for desired results.

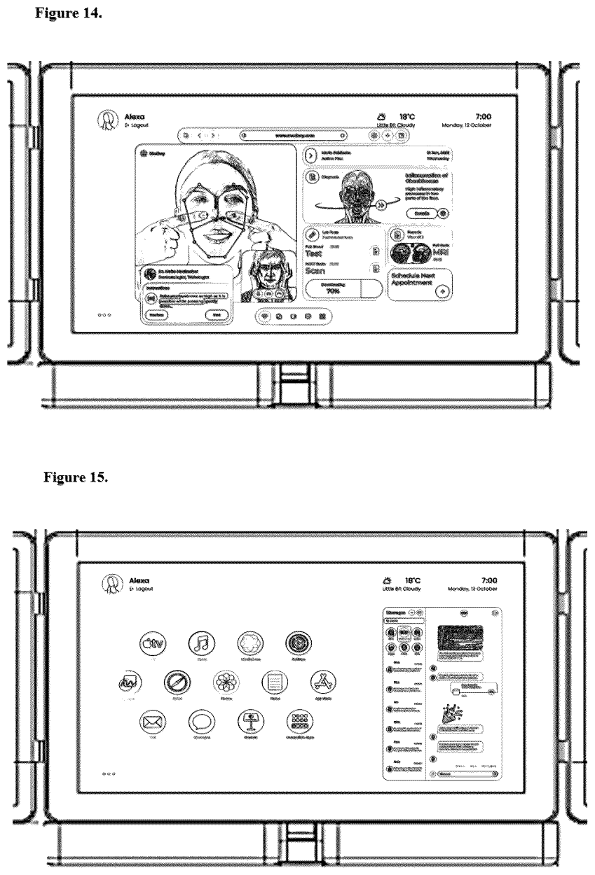

FIG. 14 illustrates the Face Fitness (Face Yoga, Face Gym, Face exercises) Screen. The Face Fitness application entails step-by-step video tutorials led by prominent face fitness (Face Yoga, Face Gym, Face exercises) mentors, allowing users to tone their facial muscles for a more rejuvenated appearance. What sets this apart is the integration of augmented reality (AR) visual aids. Through the mirror's use of cameras and electronic displays, users can experience an immersive, real-time guidance system for precise execution of each exercise.

FIG. 15 illustrates the Application and Message Screen that integrates a range of powerful embedded applications accessible directly from the home screen. Positioned as shortcuts, users can easily click on an application, prompting the transition to the Apps Screen. This dedicated space houses all the pre-installed applications on the tri-fold smart mirror, offering a seamless and user-friendly experience. Three primary applications are prominently featured on the home screen, providing quick access to essential functionalities. Users, however, have the flexibility to expand their application repertoire by installing additional apps from trusted sources like the Google Play Store or Apple Store. A distinctive feature on the Apps Screen is the Messages Window, fostering community engagement among tri-fold smart mirror users. Within this space, users can conveniently view messages from fellow community members. The platform facilitates the creation of new messages or responses to existing ones using the on-screen virtual keyboard, promoting real-time interactions and collaboration. This integration of communication within the tri-fold smart mirror's Apps Screen enhances the mirror's versatility, transforming it into a dynamic hub for both personal grooming and community engagement.

FIG. 16 showcases the Hairstyle Video Tutorial Screen, where users, upon selecting a specific tutorial, witness the chosen tutorial video on one side of the center mirror. This step-by-step guidance is complemented by the simultaneous projection of a live video feed from the

Wi-Fi camera capturing the back of the user's head on the other side of the center mirror. This dual-video setup ensures users can follow tutorials with exceptional precision, simultaneously observing the stylist's demonstration and the live feed of their own hairstyle progress. The mirror's advanced technology goes beyond mere display customization. Users have seamless control over the tutorial playback, offering a hands-free experience through touch interactions on the screen or voice recognition commands such as “play,” “pause,” “skip,” “slower,” or “faster.” This voice-controlled feature is especially valuable when both hands are engaged in holding and styling hair, eliminating the need for manual screen interaction and contributing to an uninterrupted learning experience. In addition to the customizable placement of the tutorial windows on either side of the center mirror, our innovative hairstyling app provides users with a heightened level of flexibility and personalization. Users can effortlessly drag the tutorial windows to any location on the screen that suits their preferences. Moreover, the app empowers users with the ability to pinch and zoom the tutorial windows, enabling them to configure the display precisely to their desired size and position. This synchronization between the Wi-Fi camera and the tutorial screen not only enhances user convenience but also fosters a new level of self-sufficiency in hairstyling. With the ability to configure the tutorial display, control playback effortlessly, and enjoy a synchronized dual-video setup, users can confidently master diverse hairstyles independently, redefining the way they approach and achieve their desired looks. To further enhance the interactive and personalized learning experience, users can seamlessly record their own hairstyling sessions during tutorials using the front camera integrated into the center mirror, in combination with the rear Wi-Fi camera capturing the back of the user's head. This dual-camera recording feature ensures that users can create high-definition videos showcasing both the tutorial display and their live hairstyling progress. The recorded videos are automatically saved into the tri-fold smart mirror's internal memory, providing users with a convenient way to review and assess their technique, track their progress, and revisit tutorials at their own pace. The internal memory ensures that users can store a library of their hairstyling sessions, creating a valuable resource for ongoing improvement. Additionally, the tri-fold smart mirror simplifies the process of sharing these personalized hairstyling videos with friends, family, and followers on social media platforms. With just a few taps, users can directly share their recorded videos from the tri-fold smart mirror to popular platforms such as YouTube, Instagram, TikTok, Facebook, and WhatsApp. This feature not only allows users to showcase their newfound hairstyling skills but also fosters a sense of community as they engage with others who share a passion for creative hairstyling. Incorporating recording and sharing capabilities into the tri-fold smart mirror experience adds a social dimension to the app, encouraging users to connect, inspire, and learn from one another in the ever-evolving world of hairstyling. Whether documenting a successful hairstyle replication or sharing a unique twist on a tutorial, the tri-fold smart mirror empowers users to celebrate their creativity and share their styling journey with the wider online community.

FIG. 17 illustrates the Popular Mentors Screen. The tri-fold smart mirror will feature a diverse array of highly skilled hairstylists, renowned as popular vloggers on major social media platforms like Instagram, TikTok, and YouTube. These influential individuals boast a considerable following and wield significant way over their audience's beauty and styling preferences.

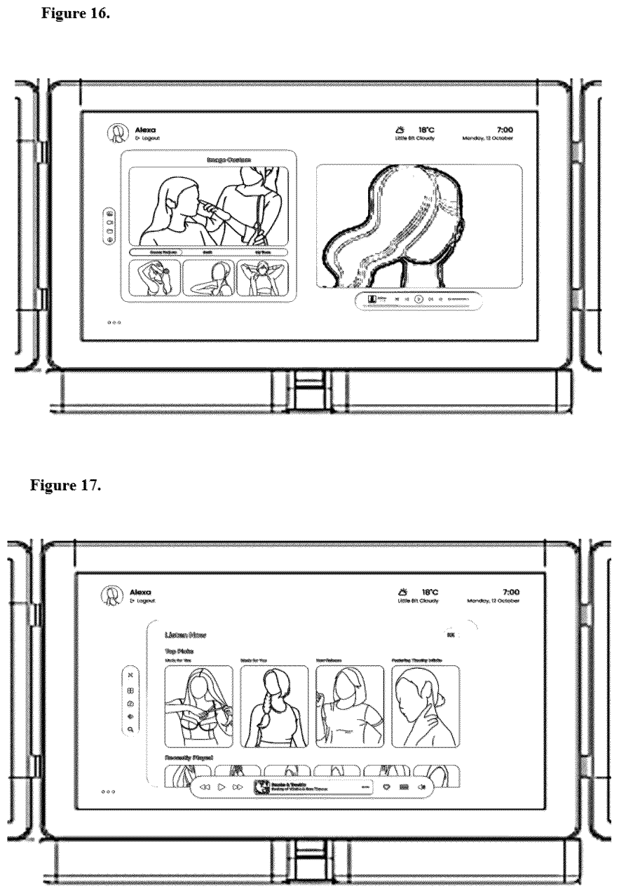

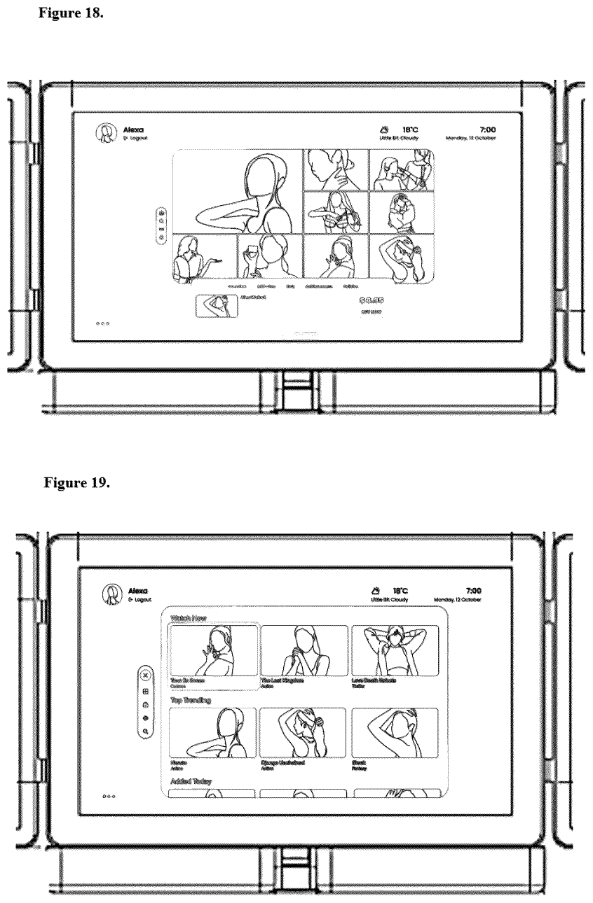

FIG. 18 illustrates the Shop/Marketplace Screen. The tri-fold smart mirror will host an integrated e-commerce marketplace, offering users the opportunity to explore and purchase the latest hair care products and accessories. Members of the tri-fold smart mirror enjoy exclusive benefits, including discounts on a wide range of the tri-fold smart mirror products, covering everything from everyday essentials to limited-edition releases. As a tri-fold smart mirror Member, users gain early access to highly anticipated product launches, ensuring they are at the forefront of the latest and most coveted offerings. As a unique bonus, users accrue Virtual Coins, a virtual currency earned through various in-app interactions. These Virtual Coins can be redeemed within the marketplace, allowing users to enjoy exclusive discounts on real products, making the tri-fold smart mirror experience not only informative and stylish but also rewarding.

FIG. 19 illustrates the My Favorites Screen. The tri-fold smart mirror serves as a personalized haven where users can curate and save their most cherished elements within the app. This feature allows users to create a tailored collection of their favorite hairstyles, ensuring easy access to go-to looks for various occasions. The My Favorites screen extends its versatility to the broader tri-fold smart mirror community. Users can bookmark and save hairstyles submitted by other tri-fold smart mirror members, fostering a sense of shared inspiration and camaraderie. By curating a collection of community hairstyles, users contribute to the collaborative and inclusive spirit of the tri-fold smart mirror. This screen aims to be a dynamic and evolving space where users can continuously refine and expand their favorites, creating a personalized reservoir of inspiration and beauty within the tri-fold smart mirror app. The My Favorites feature is designed to empower users to curate a unique and ever-growing collection reflective of their individual tastes and preferences.

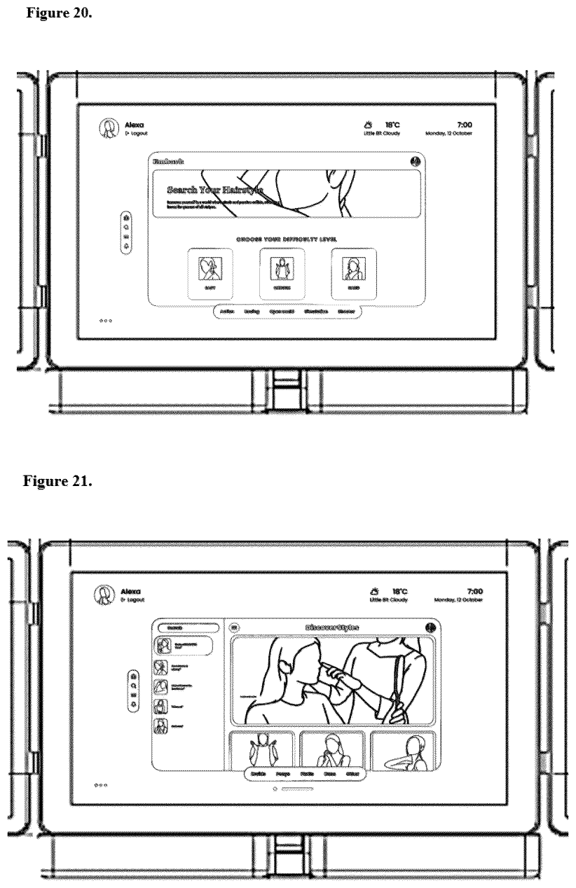

FIG. 20 illustrates the Hairstyle Search Screen. The search filter guarantees convenient access to a diverse array of hairstyling insights. Access a curated selection of exclusive the tri-fold smart mirror Salon Content tailored for esteemed members of the tri-fold smart mirror App. This thoughtfully chosen compilation of salon content provides ways to elevate a user's hair and beauty routines with expert guidance, available at a user's convenience and from any location.

FIG. 21 illustrates the Discover New Fashion Looks Screen, providing users with the flexibility to learn anytime, anywhere, offering access to numerous tutorials and exclusive partner content directly from their mobile devices. The tri-fold smart mirror's Memberships will further enhance the hair and beauty journey, offering a premium, personalized experience. These top-tier memberships not only include immersive 1-on-1 tutorials with renowned influencers but also incorporates live feedback sessions, fostering a transformative and interactive learning environment.

FIG. 22 Illustrates the Community and Social Media Screen. Within the community screen, users can connect with existing friends and make new acquaintances who share a common passion for hair and beauty. This space encourages the exchange of ideas, tips, and tricks, fostering mutual support on personal styling journeys. The tri-fold smart mirror provides a dedicated showcase for users to exhibit the impressive hairstyles achieved using the mirror, serving as a source of inspiration and motivation for others venturing into their styling endeavors.

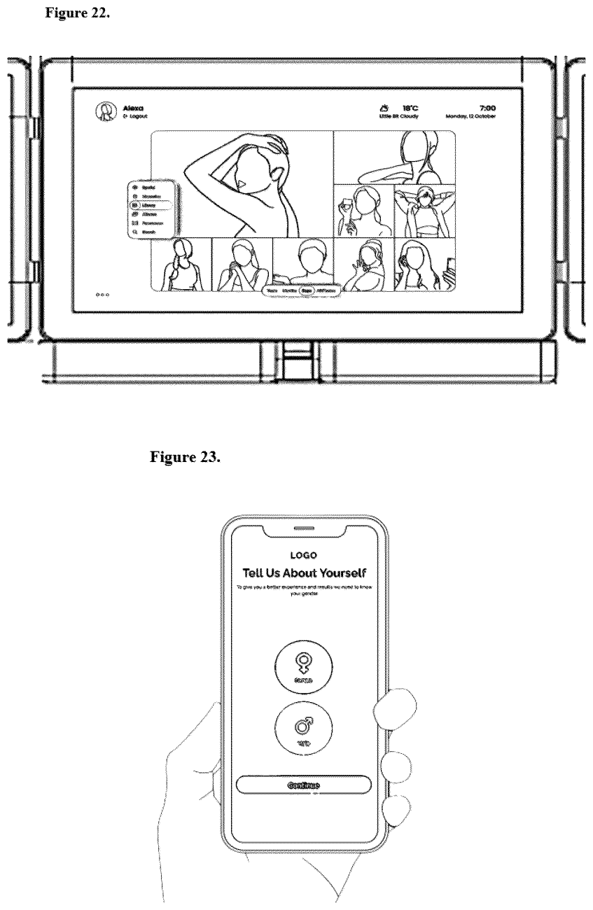

FIG. 23 illustrates part of the Onboarding Screens. During the onboarding process, the app introduces a personalized touch by inviting users to share their gender and hair length information. This unique approach enhances the user experience, allowing the application to tailor its recommendations more precisely. By understanding individual preferences and characteristics, the tri-fold smart mirror can provide more relevant and effective suggestions for its products and services. This customization ensures that users receive recommendations that align with their specific needs, promoting a more personalized and user-centric journey from the start.

FIG. 24 illustrates the Home Screen on Mobile App. The home screen provides users with a seamless and personalized experience. The home screen also features convenient shortcuts to common sections within the application such as the Marketplace, News, Community and the tri-fold smart mirror's Loyalty Program. Prominent on the home screen is a link to the app's Face Fitness (Face Yoga, Face Gym, Face exercises) section, as well as a link to begin the hairstyling experience.

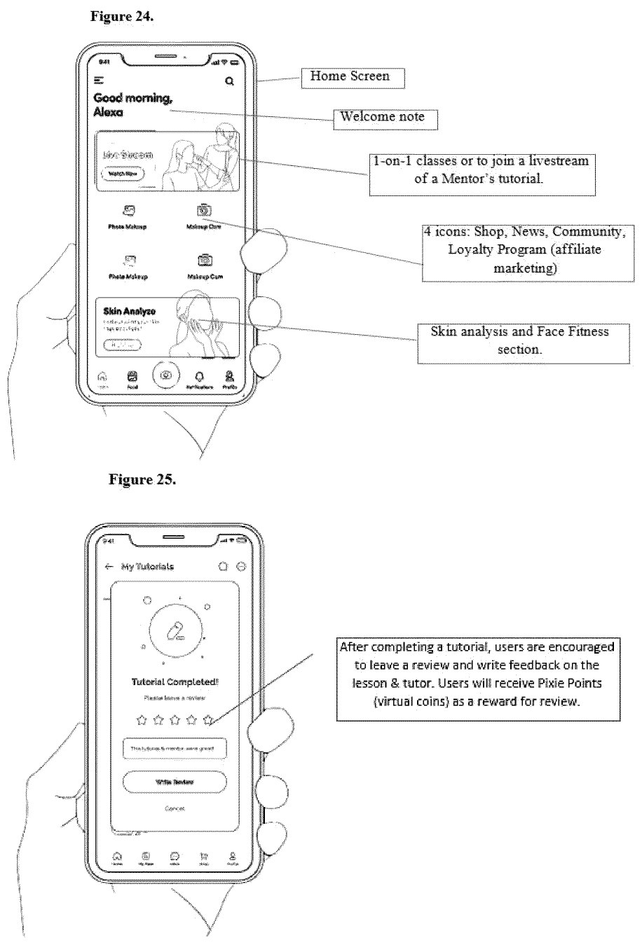

FIG. 25 illustrates the Tutorial Completion Screen. Upon completing each video tutorial, the app invites users to share their valuable feedback on both the tutorial itself and the tutor's performance. This screen will appear simultaneously on both the mobile app and the mirror. Users have the opportunity to rate the tutorial with up to 5 stars and provide a written review, offering a personalized touch to their feedback. As a token of appreciation for their insights, users are rewarded with virtual coins known as ‘Pixie Points’ when they opt to write a review. These accumulated points translate into real benefits, allowing users to redeem exclusive discounts on a range of the app's products and services. This dual-purpose review system not only encourages user engagement but also fosters a community-driven environment where experiences are shared, recognized, and celebrated.

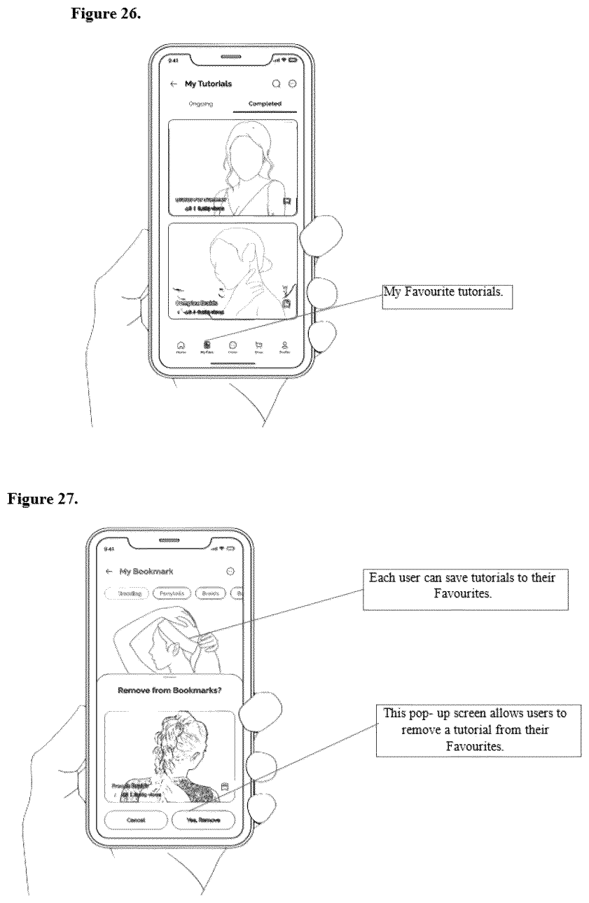

FIG. 26 illustrates a User's Favorite Tutorials Screen, which serves as a personalized haven where users can curate and save their most cherished elements within the app. This feature allows users to create a tailored collection of their favorite hairstyles, ensuring easy access to go-to looks for various occasions.

FIG. 27 illustrates how a user can add or remove Tutorials to their My Favorites Screen. Users can not only bookmark their preferred hairstyles but also save the profiles of their favorite hair mentors, establishing a curated list of mentors and influencers whose styles resonate with their personal preferences. This functionality enhances the user experience by streamlining access to preferred content creators, facilitating a more personalized learning journey. This screen aims to be a dynamic and evolving space where users can continuously refine and expand their favorites, creating a personalized reservoir of inspiration and beauty within the tri-fold smart mirror app. The My Favorites feature is designed to empower users in curating a unique and ever-growing collection reflective of their individual tastes and preferences.

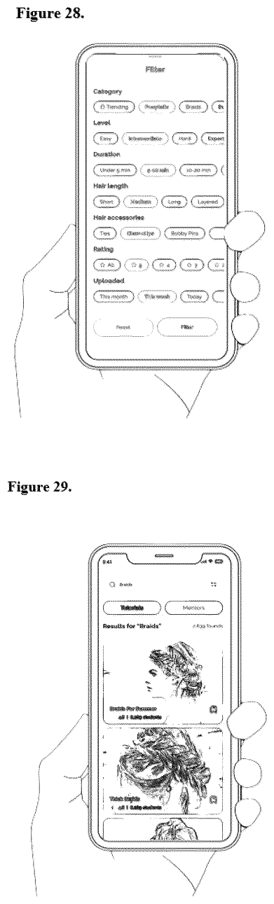

FIG. 28 illustrates the Advanced Hairstyle Filters Screen. The tri-fold smart mirror App's search filter, offering many world-class tutorials. Whether engaging with the tri-fold smart mirror at home or on the move using the tri-fold smart mirror Salon App, the search filter guarantees convenient access to a diverse array of hairstyling insights. Search filters include Category, Difficulty Level, Duration, Hair Length, Required Hair Accessories, Rating, and Uploaded.

FIG. 29 illustrates the Hairstyle Search Screen. Users can access a curated selection of exclusive the tri-fold smart mirror Salon Content tailored for esteemed members of the tri-fold smart mirror App. This thoughtfully chosen compilation of salon content provides ways to elevate a user's hair and beauty routines with expert guidance, available at a user's convenience and from any location.

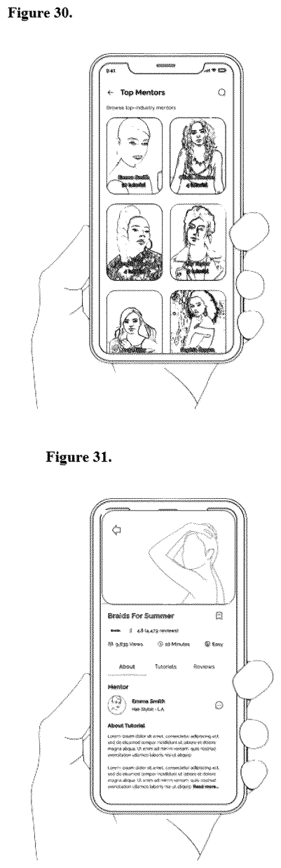

FIG. 30 illustrates the Top Mentors Screen. The tri-fold smart mirror will feature a diverse array of highly skilled hairstylists, renowned as popular vloggers on major social media platforms like Instagram, TikTok, and YouTube. These influential individuals boast a considerable following and wield significant sway over their audience's beauty and styling preferences.

FIG. 31 illustrates the Mentor's Profile Screen. Each mentor boasts a comprehensive profile featuring a detailed biography, allowing users to gain insights into their background and expertise. Users can explore a curated collection of hairstyle tutorials offered by the mentor, providing a glimpse into their unique styling approach.

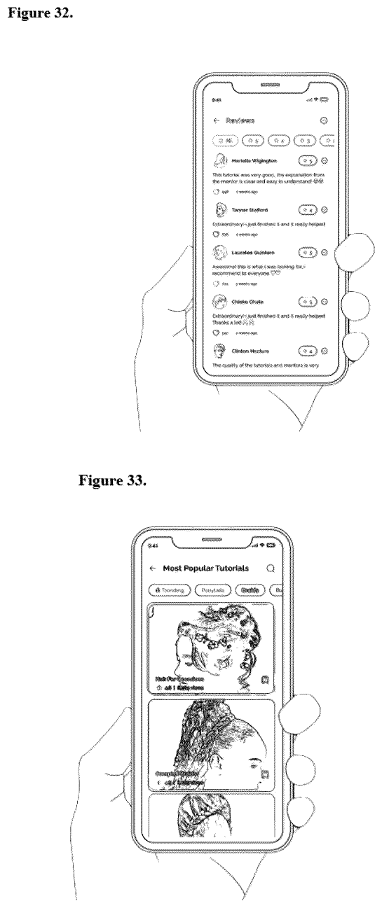

FIG. 32 illustrates the Mentor's Review Screen. The Mentor's Profile showcases authentic feedback from past participants, offering valuable insights from users who have previously engaged with the mentor's tutorials. This holistic view empowers users to make informed choices, fostering a sense of trust and connection with mentors as they embark on their hairstyling journey.

FIG. 33 illustrates the Popular Tutorials Screen, offering access to numerous tutorials and exclusive partner content directly from their mobile devices. The tri-fold smart mirror Salon Membership enhances the hair and beauty journey, offering a premium, personalized experience. This top-tier membership not only includes immersive 1-on-1 tutorials with renowned influencers but also incorporates live feedback sessions, fostering a transformative and interactive learning environments.

1. A tri-foldable smart mirror, consisting:
central mirror, and two hinged side mirrors.

2. The tri-foldable smart mirror according to claim 1, wherein the central mirror flanked by two hinged side mirrors, forming a tri-fold design.

3. The tri-foldable smart mirror according to claim 2, wherein:
the hinge pin for both right and left side mirrors measures about 120 mm length and 2.9 mm diameter of a metal, and the bottom hinge for holding bar is about 60.6 mm long and about 4.8 diameter.

4. The tri-foldable smart mirror according to claim 2, wherein the central mirror is made of plastic material with provision for built-in speakers, provision for tripod connection, headphone jack, two 2.0 USB ports and a power outlet port.

5. The tri-foldable smart mirror according to claim 4, wherein the central panel features a 13.3″ HD digital display powered by Android 11, providing interactive functionalities such as access to hairstyling tutorials, health monitoring apps, and customizable settings.

6. The tri-foldable smart mirror according to claim 5, wherein the rear of the central panel houses a concealed compartment for storing valuables and beauty accessories.

7. The tri-foldable smart mirror according to claim 1, wherein when closed, it forms a compact, flat structure, and when open, it offers a panoramic view for hairstyling.

8. The tri-foldable smart mirror according to claim 1, wherein the mirror's design is sleek and modern, with adjustable LED lighting.

9. The tri-foldable smart mirror according to claim 1, wherein the mirror is designed for hairstyling and beauty routines, integrating storage solutions and digital technology to enhance the user experience in personal grooming.

10. The tri-foldable smart mirror according to claim 9, wherein its design construction allows for tabletop, wall-mounted setups using included accessories, and tripod, catering to various user preferences.
